(19) United States
(12) Patent Application Publication
(10) Pub. No.: US 2004/0241872 A1
(43) Pub. Date: Dec. 2, 2004

(54) Optical detection liquid handling robot system

(75) Inventors: Ronald J. Wegrzyn, Walnut Creek, CA (US); Alexander A. Khorlin, Mountain View, CA (US)

Correspondence Address: BURNS DOANE SWECKER & MATHIS L L P, POST OFFICE BOX 1404, ALEXANDRIA, VA, 22313-1404, US

(73) Assignee: QIAGEN Operon, Inc., Alameda, CA (US)

(21) Appl. No.: 10/802,645

(22) Filed: Mar. 16, 2004

Related U.S. Application Data
(60) Provisional application No. 60/455,519, filed on Mar. 17, 2003.

(51) Int. Cl. B01L 3/00

(52) U.S. Cl. 436/171; 422/100; 422/63

(57) ABSTRACT

An optical detection liquid handling robot, including: a frame; a X-Y-Z robot connected to the frame; a plurality of liquid aspiration and dispensing nozzles connected to the X-Y-Z robot; a positioning system configured to position the X-Y-Z robot relative to the frame, thereby positioning the plurality of liquid aspiration and dispensing nozzles relative to the frame; a flow cell in each of the liquid aspiration and dispensing nozzles; a fiber optic probe in communication with each of the flow cells; and a spectrophotometer, wherein each of the fiber optic probes are multiplexed to the spectrophotometer.

### RELATED APPLICATION

The present application claims the benefit of priority under 35 U.S.C Section 119 to U.S. Provisional Patent Application Ser. No 60/455,519, entitled Optical Detection Liquid Handling Robot System, filed Mar. 17, 2003.

### TECHNICAL FIELD

The present invention incorporates technologies found in two different fields. As such, the present invention is specifically related to two different fields of technology. First, the present invention is related to liquid handling robots in general, and to liquid handling robots for aspirating, dispensing, mixing, transferring and reacting of various chemical and biological entities, for example, liquid handling robots for performing PCR and DNA and other oligonucleotide synthesis. Second, the present invention is also related to UV and/or visible spectral analysis tools such as systems incorporating fiber optic probes and spectrophotometers.

### BACKGROUND OF THE INVENTION

Liquid handling robots are used for high-throughput synthesis and biological or biochemical screening which includes, but is not limited to, mixing and reacting of small fluid samples of various chemical and biological entities. An important advantage of standard liquid handling robots is that they simultaneously handle a plurality of liquid samples. For example, 8 or 12 liquid samples are typically handled simultaneously in parallel. Accordingly, liquid handling robots have been especially useful when performing biological or diagnostic assays, PCR, DNA synthesis, or combinatorial chemistry. Standard liquid handling robots are used by a variety of companies when performing these many liquid handling protocols including QIAGEN, Illumina, IDT, Invitrogen, Sigma-Genosys, and MWG Biotech.

Existing liquid handling robots are typically used with standard reaction well plates (most commonly standard 96-well or 384-well plates). Such plates are positioned on the top/back of the liquid handling robot, with the moveable nozzles of the liquid handling robot then being used to aspirate and then dispense various fluids among the various wells of the reaction well plates. Movement of an independently operable positive displacement syringe is typically used to aspirate or dispense liquid from the various liquid nozzles.

Existing liquid handling robot/reaction well plate systems have proven to be very useful when performing a very high number of reactions per hour or per day, due to their small sample size, and their ability to simultaneously perform a variety of mixing and fluid transfer operations.

Spectrophotometric analysis has proven very useful in analyzing the compounds present in various chemical and biological reactions. However, current methods still rely on the liquid handling systems to set up the reactions or aliquoting processes followed by a robotic or human intervention to transfer the reaction plate to the spectrophotometric reader for analysis.

The performance of fast, real time assays, reactions or measurements is difficult, if not impossible; because the current technology requires the discreet liquid handling reactions set up followed by the transfer to the spectrophotometric reader for analysis. A further difficulty is that the reaction may have already been completed during the time required to transfer the reaction plate from the liquid handling stage to the analysis stage. This may result in a complete loss of data.

### SUMMARY OF THE INVENTION

In preferred aspects, the present invention provides an optical detection liquid handling system, including: a frame; an X-Y-Z robot connected to the frame; a plurality of liquid aspiration and dispensing nozzles connected to the X-Y-Z robot; a positioning system configured to position the X-Y-Z robot relative to the frame, thereby positioning the plurality of liquid aspiration and dispensing nozzles relative to the frame; a flow cell incorporated in each of the liquid aspiration and dispensing nozzles; a fiber optic probe directly optically monitoring the sample within each of the flow cells; and a spectrophotometer which is multiplexed to receive optical signals from each of the fiber optic probes. In preferred embodiments, the liquid aspiration and dispensing nozzles are independently operable. In preferred aspects, a positive displacement syringe is used to cause the nozzles to either dispense or aspirate liquid.

In optional preferred aspects, the flow cell comprises a portion of the liquid aspiration and dispensing nozzle that is transparent. Such transparent portion may optionally comprise an optically clear element on either side of the liquid phase. The optically clear element may be made of sapphire. In optional preferred aspects, each fiber optic probe comprises at least a pair of fiber optic cables, with each cable extending from locations around the flow cell.

In optional preferred aspects, the volume of the flow cell is less than 50 ul, and more preferably less than 20 ul.

The present invention also provides a method of spectrophotometrically analyzing a plurality of liquid samples in real time, including: aspirating the plurality of liquid samples into a corresponding plurality of liquid aspiration and dispensing nozzles in a liquid handling robot; passing light through a flow cell in each of the liquid aspiration and dispensing nozzles; and spectrophotometrically analyzing the light passing through each of the flow cells. In preferred aspects, the concentration of the product in the flow cells is analyzed, and data is sent to a control system that commands the liquid handling robot to adjust the final product in the reaction wells by the addition of liquid water diluent or the addition or removal of product.

In optional preferred aspects, passing light through a flow cell in each of the liquid aspiration and dispensing nozzles containing the liquid samples includes passing light through at least a pair of fiber optic cables, wherein each cable extends from locations around the flow cell.

In optional preferred aspects, spectrophotometrically analyzing the light passing through each of the flow cells comprises sequentially analyzing the light passing through at least a pair of fiber optic cables (per flow cell) multiplexed to a spectrophotometer. In optional preferred aspects, the light passing through each of the flow cells is spectrophotometrically analyzed while a reaction is performed within the flow cell. Such reaction may include, but is not limited to: chemical, biochemical, biomedical or biological reactions, biochemical and diagnostic assays, PCR related methodologies as well as nucleic acid and peptide synthesis. Such reaction may also include pharmaceutical, pharmacological or any form of biomedical reactions in general.

A first advantage of the present integrated liquid handling and spectrophotometric analysis system is the ability to conduct reaction analysis and monitored synthesis in real time. This is due to the fact that the spectrophotometric analysis is carried out within the liquid aspiration and dispensing nozzle itself. Thus, it is possible to perform reaction setup and spectrophotometric analysis concurrently. In contrast, in current approaches, the liquid handling is first carried out in one machine, and then spectrophotometric analysis is carried out in another machine. Therefore, one must wait until after the reaction has completed (or at least has already progressed for some time) prior to commencing the spectrophotometric analysis.

A further advantage of the present invention is that separate liquid handling robot and spectrophotometer machines are not required. Rather, the present invention combines the benefits of both systems into a single integrated liquid handling and analysis platform. Therefore, further advantages are realized. For example, extra time is not required to transfer reaction well plates between machines. Thus, the potential for atmospheric contamination, spillage and cross-contamination among adjacent reaction wells is minimized. In addition, it is not necessary that the reaction well plate need to be made out of a transparent material.

A further advantage of the present invention is the high speed at which it may carry out the spectrophotometric analysis. As will be explained, such high speed may be achieved at least in part by the multiplexing of the various fiber optic probes with the spectrophotometer of the device.

In addition, the present invention is very accurate. Such accuracy may be achieved at least in part by fact that the spectrophotometric analysis is performed within each of the liquid aspiration and dispensing nozzles, and specifically within the small flow cell in each of the liquid handling (i.e. aspirating and dispensing) nozzles.

In alternate embodiments of the present invention, the liquid aspirating and dispensing nozzles need not be connected to positive displacement syringes, but may instead be connected to any suitable mechanism for fluid displacement or transfer. In addition, alternate systems of fluid loading may be used.

### BRIEF DESCRIPTION OF THE DRAWINGS

FIG. 1 is a perspective view of the present optical detection liquid handling robot system (with the fiber optic probes and aspiration/dispensing pressure lines removed for clarity of illustration).

FIG. 2 is a side elevation view of eight independently operable liquid aspiration and dispensing nozzles, showing the fiber optic probe cables (in dotted lines) communicating with flow cells in each of the nozzles, and also showing the aspiration/dispensing of one of the pressure lines associated with one of the nozzles.

FIG. 3 is a schematic view of a pair of fiber optic probe cables in communication with a flow cell in one of the nozzles, with the fiber optic probe cables in communication with a spectrophotometer.

FIG. 4. is a schematic view of three different liquid nozzles multiplexed to the spectrophotometer.

### DETAILED DESCRIPTION OF THE DRAWINGS

In preferred aspects, the present invention provides a system to analyze the liquid flow within the probes of a liquid handling robotic system. The liquid handling probes may incorporate a flow cell with fiber optic implementation to monitor UV and/or visible natural or synthetic absorptive compounds within the range of 190 nm to 800 nm, including, but not limited to, nucleic acids and the components thereof, oligonucleotides and the components thereof, antibodies and the components thereof, antibodies and the components thereof, proteins and/or peptides and the components thereof, fluorescent compounds or any other biological, chemical or biochemical or pharmacological samples and the components thereof, cell based reactions and the components thereof, PCR or related technologies and the components thereof, all of which may be in the areas of research and diagnostics, but are not so limited.

Examples of suitable fiber optic probes that may be incorporated into the present invention are described in U.S. Pat. Nos. 6,292,610; 6,205,272; 5,978,534; and 5,774,610. It is to be understood, however, that any suitable optical probe may be used, all keeping within the scope of the present invention. An example of a multiplexed spectrophotometer system that may be incorporated into the present invention is described in U.S. Pat. No. 5,953,118. It is to be understood, however, that any suitable spectrophotometer may be used, all keeping within the scope of the present invention.

The present invention thus advantageously provides the incorporation of two separate technology processes of: (1) the aspirating dispensing, mixing transferring and reacting of chemical, biological entities, with (2) the UV and/or visible spectrum analysis tool into the probes/nozzles of a liquid handling robotics system.

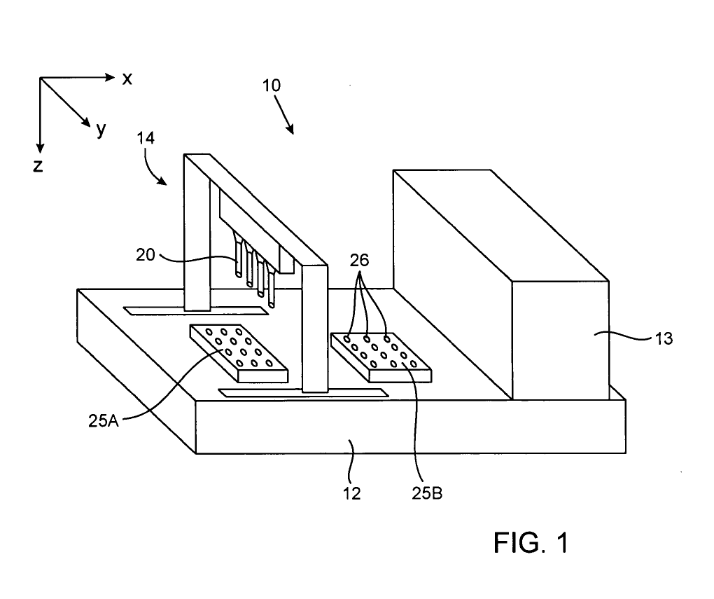

Referring first to FIG. 1, the present invention provides an optical detection liquid handling system 10 having a frame 12 and an X-Y-Z robot 14 connected to frame 12. Robot 14 (and its associated positioning system) is configured to move nozzles 20 in perpendicular X, Y and Z directions, as shown. Preferably, the positioning system for robot 14 comprises circuitry disposed within housing 13. However, the positioning system for robot 14 need not be positioned within housing 13. For example, such positioning system may instead be disposed at a remote location.

System 10 is used to simultaneously position a plurality of nozzles 20 with respect to standard reaction well plates 25A and 25B (which are placed on the top/back of frame 12, as shown). Plates 25A and 25B may be standard 96 well or 384 well plates, or any other design. For ease of illustration plates 25A and 25B are only shown as having twelve wells. As will be explained, liquids are first drawn up into nozzles 20 (for example, from first reaction wells in plate 25A). Then, the nozzles are moved together to a new location (for example, above and then down into reaction wells in plate 25B). Then, the liquids in nozzles 20 may be dispensed into these reaction wells. Accordingly, by moving X-Y-Z robot 14 and by aspirating and dispensing liquids from nozzles 20, small liquid samples may be simultaneously transferred and mixed as desired. For ease of illustration, only four nozzles 20 are shown in FIG. 1. The present invention is not so limited. Instead, eight or twelve nozzles 20 are typically used together. (Moreover, the fiber optic probes and aspiration/dispensing pressure lines have also been removed from FIG. 1 for clarity of illustration).

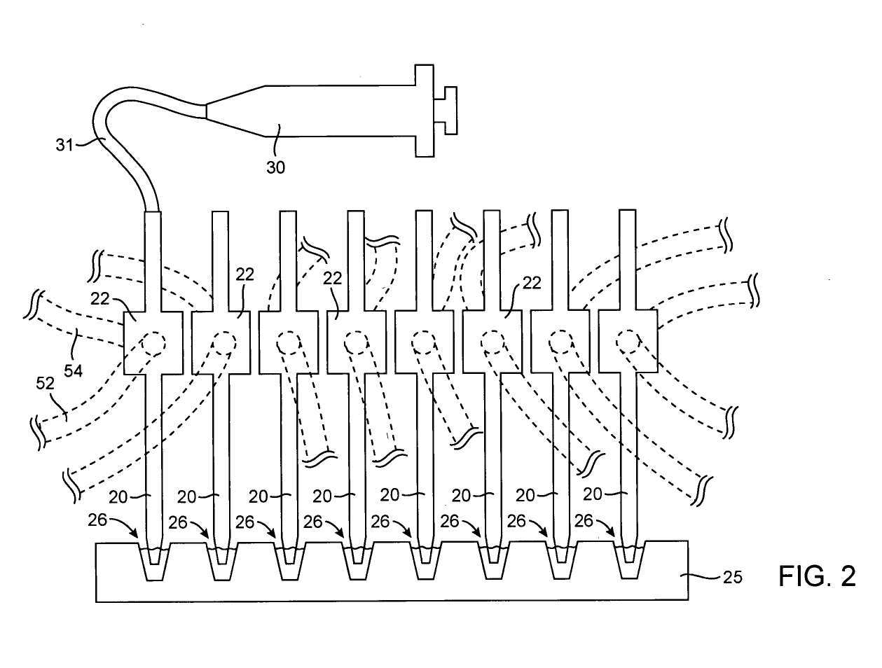

Referring next to FIG. 2, eight nozzles 20 are shown. Typically, nozzles 20 are positioned in a straight line (as shown) and are mounted to an X-Y-Z robot 14 (FIG. 1). Each nozzle 20 is connected to a separate positive displacement syringe 30 by pressure line 31 (for ease of illustration, only one syringe 30 and pressure line 31 is shown). Preferably, the positive displacement syringes 30 are disposed within housing 13 (FIG. 1), but alternate locations are also possible. When the pressure in positive displacement syringe 30 is decreased, liquid is drawn into nozzle 20 from reaction well 26 in plate 25. Conversely, when the pressure in positive displacement syringe 30 is increased, liquid is instead dispensed from nozzle 20 into reaction well 26. In the illustrated embodiment, each of nozzles 20 has a dedicated positive displacement syringe 30 and each is thus independently operable. It is to be understood, however, that the present invention is not so limited. For example, two or more of nozzles 20 may instead be operated in parallel (e.g.: several nozzles 20 may share a single positive displacement syringe 30 or equivalent system).

In accordance with the present invention, a system for performing spectrophotometric analysis of the liquid samples while the liquid samples are disposed in the nozzles 20 is provided. Specifically, each nozzle 20 includes a flow cell 22. Flow cell 22 may simply comprise a portion of nozzle 20 through into which liquid is aspirated.

Flow cell 22 preferably comprises a portion of nozzle 20 that is transparent, and may in optional embodiments comprise a clear wall on either side of nozzle 20. Optionally, such clear wall may be made of sapphire, but alternate materials are also possible, including, but not limited to, quartz. In one preferred embodiment, flow cell 20 has a volume less than 50 ul. In another preferred embodiment, flow cell 20 has a volume less than 20 ul.

Spectrophotometric analysis may by carried out as follows. Each flow cell 22 is in communication with a fiber optic probe such that light passing through (e.g. across) the flow cell is in communication with a spectrophotometer, as follows. Preferably, the fiber optic probe comprises a pair of fiber optic cables 52 and 54 that is associated with each flow cell 22, with one cable extending from each of the opposite sides of the flow cell.

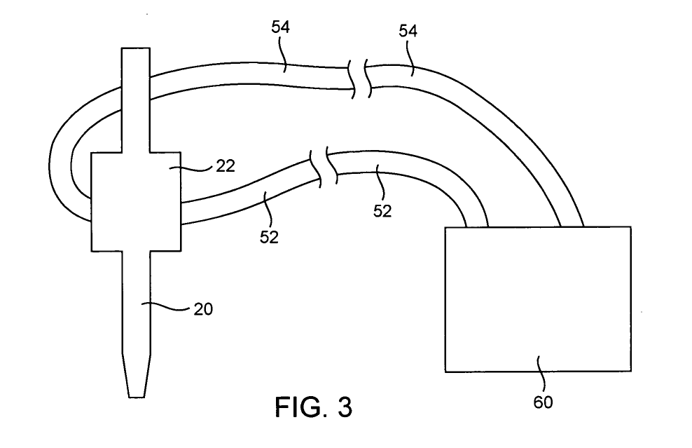

Referring to FIG. 3, a single nozzle 20 is shown. Nozzle 20 includes a flow cell 22 with a first fiber optic cable 52 and a second fiber optic cable 54 extending from opposite sides of flow cell 22. Fiber optic cable 52 and 54 are connected to a spectrophotometer 60 such that light passing through cables 52 and 54 passes through flow cell 22, and can thus be analyzed by spectrophotometer 60.

Spectrophotometer 60 is preferably configured to analyze light in the 190 nm to 800 nm range, thus including visible and ultraviolet light. In certain preferred embodiments, spectrophotometer is configured to analyze light in the 220 nm to 700 n range. As such, spectrophotometer 60 can be used to measure the optical density of the liquid within flow cells 20 (and thus determine the contents of the flow cells 20 by the spectrophotometric signatures of such compounds. Preferably, spectrophotometer 60 is disposed within housing 13 (FIG. 1), but alternate locations are also contemplated, all keeping within the scope of the present invention.

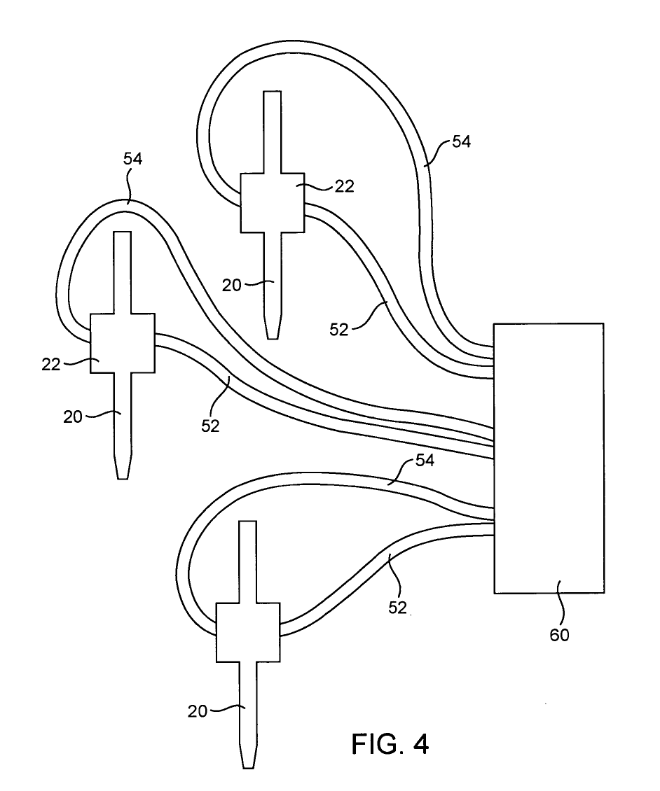

FIG. 4 schematically shows the “multiplexing” of the present invention. For ease of illustration, three nozzles 20 (each having flow cells 22) are shown. It is to be understood that eight nozzles 20 are typically used, and are positioned in a straight line (as in FIG. 2), but alternate configurations are possible. A pair of fiber optic cables 52 and 54 are associated with each flow cell 22. A single spectrophotometer 60 is used to sequentially analyzing the light passing through each flow cell 22. Specifically, spectrophotometer 60 first analyzes the light passing through a first pair of fiber optic cables 52 and 54, and then analyzes the light passing through a second pair of fiber optic cables 52 and 54, and so on.

An advantage of such multiplexing is that only one spectrophotometer 60 is required to analyze a number of different liquid samples in the various flow cells 22. Moreover, by rapidly repeating such multiplexing (i.e.: alternating among the various flow cells by alternating among the various pairs of cables 52 and 54 in rapid succession), it would be possible to perform near simultaneous spectrophotometric analysis of different reactions occurring over time in different flow cells.

In various uses of the present invention, the reaction which is analyzed in the flow cell may include, but is not limited to, nucleic acid synthesis, modification or degradation and the components thereof; biochemical reactions including, but not limited to, enzyme reactions including the components thereof; chemical reactions including the components thereof, cell based reactions including the components thereof; PCR or related technologies and components thereof; UV and/or visible natural or synthetic absorptive compound reactions within the range of 190 nm to 800 nm in the areas of, but not limited to research and diagnostics; nucleic acid reactions and oligonucleotides including the components thereof; antibody reactions including the components thereof; protein and/or peptide reactions including the components thereof; fluorescent compound reactions including the components thereof, biological fluid reactions including the components thereof.

The present invention also comprises the method of spectrophotometrically analyzing a plurality of liquid samples, by: aspirating the plurality of liquid samples into a corresponding plurality of liquid aspiration and dispensing nozzles 20 in a liquid handling robot 14; passing light through flow cell 22 in each of nozzles 20; and spectrophotometrically analyzing the light passing through each of flow cells 22 with spectrophotometer 60. Optionally, the preferred method also includes: moving nozzles 20 on X-Y-Z axes of liquid handling robot 14; and dispensing the plurality of liquid samples from the corresponding nozzles 20; and repeating the aspirating and dispensing of liquid samples to optimize liquid product concentration characteristics based on results of the spectrophotometric analysis.

In one preferred use of the present invention, the samples are pharmacological samples. As such, the present invention can be used for either or both of (1) drug discovery, or (2) drug testing.

For example, the present invention can also be used in the method of doing business of: simultaneously reacting a plurality of samples in a plurality of liquid aspiration and dispensing nozzles 20 in a liquid handing robot 14; spectrophotometrically analyzing each of the plurality of samples in the plurality of nozzles 20 with a spectrophotometer 60 multiplexed thereto; and compiling result data of the spectrophotometric analysis of each of the plurality of samples. An advantage of the present invention is that these samples can be analyzed in real time.

Optionally, one or more of the samples can be selected (for further analysis, testing or use) by analyzing the compiled results of the spectrophotometric analysis of each of the plurality of samples. This may be especially beneficial in drug discovery or testing.

Optionally as well, the data (i.e.: the resulting data of the spectrophotometric analysis of each of the plurality of samples) compiled by the method and system of the present invention may then be exported. For example, the data may be downloaded, uploaded or transferred by data lines to other party, or to another piece or system of equipment.

### Examples of Use of The Present Invention:

The present inventors have successfully built and tested the present invention. The present invention provided complete functionality in regards to the normal range of aspiration, dispensing, and transferring of small volume liquids of less than 10 ml within a defined workspace or deck. In the tested embodiment of the present invention, the flow cells are incorporated at the distal end of each liquid handling probe at 44 mm from the tip with a detection range from 220 to 700 nm. (It is to be understood that these distances and ranges are merely exemplary; the present invention is not so limited). The present inventors demonstrated that the present invention was perfectly suited for production product line analysis with concentration and or volume adjustment.

The instrument that was built and tested by the present inventors used components of the BioRobot-8000™ system (made by QIAGEN Instruments, AG of Hombrechtikon, Switzerland), and included optical flow cells and a multiplexer spectrophotometer hereinafter referred to as the “BioRobot-UV” system. The BioRobot-UV was tested using samples of Qiagen/Operon production oligos. The samples were also tested in the SpectraMax_190™ system (made by Molecular Devices Corporation, Sunnyvale, Calf. 94089-1136) and compared with the data derived from the BioRobot-UV. As can be seen below, the BioRobot-UV measurements were linear for all eight probes through the series of diluted samples, which were tested, indicated the capability of the flow cells and spectrophotometer to consistently and reproducibly read through a range of sample concentrations. See Illustrations 1 & 2 below.

The BioRobot-UV was also tested with a known standard d-Thymidine (dT) solution. The standard dT solution was diluted using a 2-fold dilution series into deionized water. The diluted samples were measured with each of the eight BioRobot-UV probes and the calculated molar concentration data for each probe at each diluted concentration is shown with the empirically calculated data in Table 1. The measured concentrations were comparable to the calculated concentrations through the range tested as shown by mean values for BioRobot-UV compared to the empirical calculations. The data for the eight probes remained consistent with each other with little variation from probe to probe except at the higher concentrations as shown by the S.E.M. data.

The flow cell detectors were incorporated at the distil end of the probes at a distance of 44 mm from the tips. The intervention of the flow cell mechanism was evaluated for potential disruptions in the ability of the BioRobot-UV to aspirate or dispense specified volumes. The BioRobot-UV was set to aspirate and dispense volumes of 50, 90 and 180 ul and each volume was dispensed three times. The volumes were measured by path length using a SpectraMax 190. The lowest volume dispensed, 50 ul (Illustration 3), demonstrated the most variability. The dispense volumes of 90 and 180 ul were fairly consistent (Illustrations 4 & 5).

The flow cells were directly calibrated to the SpectraMax-190 ™ plate reader (Molecular Devices Corporation, Sunnyvale, Calf. 94089-1136) for convenient measurement comparisons. The absorption values at 260 nm are measured for individual solutions of single stranded DNA contained in 96 well plates. The test was repeated with three different plates of single stranded DNA oligos. The DNA samples were measured first by removing a sample, followed by dilution of the sample and measurement using the SpectraMax-190™ plate reader. The samples were then analyzed directly by aspiration into the BioRobot-UV flow cells, measured, and dispensed back into the sample wells where they originated. The DNA samples were measured at an absorbance of 260 nm. The data sets from both procedures were compared as paired data in a t-test. The mean values for the sample populations from the SpectraMax and BioRobot-UV were not significantly different at p<0.05. The null hypothesis states that the two populations are different. From the sampling data we can conclude that there is a probability between 0.5024 and 0.7552 of observing a difference at least as large as or larger than was observed if the null hypothesis was true. (See Illustrations 6, 7 & 8 below).

The BioRobot-UV system was also evaluated to perform a Concentration Normalization procedure on a solution of single stranded DNA product. Newly synthesized product DNA requires final adjustment to customer specifications (Table 2). The DNA samples contained in 96 well plates will be sampled, measured and adjusted as necessary. The BioRobot-UV will aspirate defined sample volumes simultaneously from 1 to 8 wells of a 96 well plate into flow cells. The samples are measured for absorption at 260 nm. The Absorbance₂₆₀ data is captured and uploaded to the database containing the extinction coefficient and information necessary to determine the concentration as pmoles/μl. Based on the customer specifications of Target Conc and Target Volume previously loaded into the database the appropriate DNA sample volume and water diluent are determined and directly downloaded to the BioRobot-UV where immediate aspiration and dispensing of the DNA sample and water diluent is completed (Table 2).

The Concentration Normalized plate was validated using the SpectraMax-190 and compared to the empirically derived concentration. This is shown in the last two columns of Table 2 and graphically in Illustration 9.

Table 2 (below): This table shows a subset of the database information applying to the BioRobot-UV. Information is provided about the samples in the form of well location and extinction coefficient 260. Customer specifications are incorporated as Target Conc and Target Volume. The Odvalue BR-UV is the flow cell data of absorbance at 260 nm derived from the BioRobot-UV. The Sample Volume and Diluent Volume represents the resulting adjustments required to bring the DNA sample to the customer specifications. The data was validated by reading the absorbance values on the SpectraMax-190 after the final sample and volume adjustment.

[image]

[image]

[image]

[image]

TABLE 1

| FOLD- | PROBE | PROBE | PROBE | PROBE | PROBE | PROBE | PROBE | PROBE | MEAN | | EMPERICAL |
|---|---|---|---|---|---|---|---|---|---|---|---|
| DILUTION | 1 | 2 | 3 | 4 | 5 | 6 | 7 | 8 | uM | SEM | uM |
| 2 | 2861.61 | 2855.91 | 2894.90 | 2803.23 | 2841.10 | 2892.62 | 2767.79 | 2725.59 | 2830.3 | 21.3 | 2838 |
| 4 | 1486.94 | 1431.77 | 1485.52 | 1439.29 | 1499.90 | 1474.16 | 1408.78 | 1450.16 | 1459.57 | 11.27 | 1419 |
| 8 | 754.69 | 708.57 | 755.05 | 725.49 | 767.88 | 742.97 | 710.68 | 734.78 | 737.51 | 7.635 | 710 |
| 16 | 384.12 | 342.95 | 382.17 | 365.90 | 390.72 | 368.20 | 357.32 | 371.29 | 370.34 | 5.493 | 355 |
| 32 | 196.02 | 163.70 | 191.78 | 183.63 | 197.36 | 182.20 | 178.34 | 184.02 | 184.63 | 3.845 | 178 |
| 64 | 103.34 | 71.86 | 98.15 | 92.65 | 100.94 | 80.89 | 89.33 | 93.80 | 91.37 | 3.739 | 89 |
| 128 | 56.35 | 38.64 | 50.84 | 47.25 | 50.49 | 38.50 | 45.70 | 48.47 | 47.03 | 2.156 | 44 |
| 256 | 34.21 | 18.90 | 25.08 | 24.68 | 27.31 | 16.82 | 23.53 | 25.93 | 24.56 | 1.87 | 22 |

TABLE 2

| | | | | | | | | ABS VALUES | EXPECTED ABS |
|---|---|---|---|---|---|---|---|---|---|
| PLATE | | Actual | Target | Target | Odvalue | Sample | Diluent | SPECTRAMAX | AFTER |
| WELL | Extinction | Conc | Conc | Volume | BR-UV | Volume | Volume | AFTER ADJUST | ADJUSTMENT |
| A1 | 701106.4 | 23.7 | 10 | 200 | 1.663 | 84.34 | 115.66 | 0.681 | 0.701 |
| B1 | 648098.0 | 25.6 | 20 | 250 | 1.661 | 195.06 | 54.94 | 1.387 | 1.296 |
| C1 | 695730.8 | 23.9 | 15 | 100 | 1.666 | 62.64 | 37.36 | 1.066 | 1.044 |
| D1 | 657113.7 | 25.8 | 10 | 200 | 1.696 | 77.51 | 122.49 | 0.598 | 0.657 |
| E1 | 653277.8 | 26.2 | 25 | 200 | 1.711 | 190.92 | 9.08 | 1.614 | 1.633 |
| F1 | 674717.9 | 24.9 | 10 | 150 | 1.682 | 60.16 | 89.84 | 0.690 | 0.675 |
| A2 | 693140.9 | 26.2 | 10 | 200 | 1.817 | 76.29 | 123.71 | 0.616 | 0.693 |
| B2 | 707105.0 | 24.6 | 20 | 250 | 1.740 | 203.14 | 46.86 | 1.509 | 1.414 |
| C2 | 674717.9 | 23.4 | 15 | 100 | 1.579 | 64.11 | 35.89 | 1.062 | 1.012 |
| D2 | 666227.3 | 25.2 | 10 | 200 | 1.676 | 79.49 | 120.51 | 0.594 | 0.666 |
| E2 | 653082.0 | 27.2 | 25 | 200 | 1.776 | 183.90 | 16.10 | 1.592 | 1.633 |
| F2 | 724611.3 | 22.9 | 10 | 150 | 1.660 | 65.48 | 84.52 | 0.726 | 0.725 |
| A3 | 681437.4 | 24.3 | 10 | 200 | 1.658 | 82.18 | 117.82 | 0.723 | 0.681 |
| B3 | 684125.2 | 25.6 | 20 | 250 | 1.753 | 195.12 | 54.88 | 1.474 | 1.368 |
| C3 | 651836.0 | 25.6 | 15 | 100 | 1.669 | 58.57 | 41.43 | 1.059 | 0.978 |
| D3 | 670882.0 | 25.0 | 10 | 200 | 1.677 | 80.03 | 119.97 | 0.692 | 0.671 |
| E3 | 706188.3 | 25.1 | 25 | 200 | 1.771 | 199.35 | 0.65 | 1.703 | 1.765 |
| F3 | 720250.3 | 24.8 | 10 | 150 | 1.787 | 60.47 | 89.53 | 0.657 | 0.720 |
| A4 | 688584.1 | 25.7 | 10 | 200 | 1.770 | 77.82 | 122.18 | 0.712 | 0.689 |
| B4 | 703598.4 | 24.4 | 20 | 250 | 1.715 | 205.10 | 44.90 | 1.441 | 1.407 |
| C4 | 666227.3 | 24.3 | 15 | 100 | 1.618 | 61.76 | 38.24 | 1.057 | 0.999 |
| D4 | 708974.0 | 24.6 | 10 | 200 | 1.745 | 81.26 | 118.74 | 0.658 | 0.709 |
| E4 | 647181.3 | 27.1 | 25 | 200 | 1.757 | 184.22 | 15.78 | 1.575 | 1.618 |
| F4 | 691797.0 | 24.2 | 10 | 150 | 1.673 | 62.04 | 87.96 | 0.669 | 0.692 |

What is claimed is:

1. An optical detection liquid handling system, comprising:
a frame;
an X-Y-Z robot connected to the frame;
a plurality of liquid aspiration and dispensing nozzles connected to the X-Y-Z robot;
a positioning system configured to position the X-Y-Z robot relative to the frame, thereby positioning the plurality of liquid aspiration and dispensing nozzles relative to the frame;
a flow cell in each of the liquid aspiration and dispensing nozzles;
a fiber optic probe in communication with each of the flow cells; and
a spectrophotometer, wherein each of the fiber optic probes are multiplexed to the spectrophotometer.

2. The system of claim 1, further comprising:
a positive displacement syringe or other mechanisms of liquid displacement or transfer in communication with each of the liquid aspiration and dispensing nozzles, wherein movement of the positive displacement syringe causes the liquid aspiration and dispensing nozzle to either dispense or to aspirate liquid.

3. The system of claim 1, wherein the flow cell comprises a portion of the liquid aspiration and dispensing nozzle that is optically transparent to light in the wavelength of 190 nm to 800 nm.

4. The system of claim 1, wherein the flow cell comprises an optically transparent element on either side of the liquid aspiration and dispensing nozzle.

5. The system of claim 4, wherein each optically transparent element is capable of light transmission in the 190 nm to 800 nm range.

6. The system of claim 1, wherein each fiber optic probe comprises at least a pair of fiber optic cables, with each cable extending from locations around the flow cell.

7. The system of claim 1, wherein the spectrophotometer is adapted to analyze light in the 190 to 800 nm range.

8. The system of claim 7, wherein the spectrophotometer is adapted to analyze ultraviolet light.

9. The system of claim 7, wherein the spectrophotometer is adapted to analyze visible light.

10. The system of claim 1, wherein the frame is adapted to receive standard reaction well plates thereon such that the liquid aspiration and dispensing nozzles can be moved over or into the reaction wells of the reaction well plate.

11. The system of claim 10, wherein the standard reaction well plate comprises a single reaction well or a multiple arrangement of reaction wells.

12. The system of claim 10, wherein the standard reaction well plate is a 96 well reaction plate.

13. The system of claim 1, wherein the spectrophotometer measures the absorption or transmittance of light within the range of 190 nm to 800 nm through the liquid within the flow cells.

14. The system of claim 1, wherein a volume of the flow cell is less than 50 ul.

15. The system of claim 1, wherein a volume of the flow cell is less than 20 ul.

16. A method of spectrophotometrically analyzing a plurality of liquid samples, comprising:
aspirating the plurality of liquid samples into a corresponding plurality of liquid aspiration and dispensing nozzles in a liquid handling robot;
passing light through a flow cell in each of the liquid aspiration and dispensing nozzles containing the liquid samples; and
spectrophotometrically analyzing the light passing through each of the flow cells.

17. The method of claim 16, wherein passing light through a flow cell in each of the liquid aspiration and dispensing nozzles comprises:
passing light through at least a pair of fiber optic cables, wherein each cable extends from a location around the flow cell.

18. The method of claim 16, wherein spectrophotometrically analyzing the light passing through each of the flow cells comprises:
sequentially analyzing the light passing through the fiber optic cables with a spectrophotometer, wherein at least a pair of fiber optic cables are multiplexed to the spectrophotometer.

19. The method of claim 16, wherein the light passing through each of the flow cells is spectrophotometrically analyzed while a reaction is performed within the flow cell.

20. The method of claim 19, wherein the reaction comprises nucleic acid synthesis or degradation and the components thereof.

21. The method of claim 19, wherein the reaction is biochemical including the components thereof.

22. The method of claim 19, wherein the reaction is chemical including the components thereof.

23. The method of claim 19, wherein the reaction is cell based including the components thereof.

24. The method of claim 19, wherein the reaction is PCR and components thereof.

25. The method of claim 19, wherein the reaction is UV and/or visible natural or synthetic absorptive compounds within the range of 190 nm to 800 nm.

26. The method of claim 19, wherein the reaction is with nucleic acids and oligonucleotides including the components thereof.

27. The method of claim 19, wherein the reaction is with antibodies including the components thereof.

28. The method of claim 19, wherein the reaction is with proteins and/or peptides including the components thereof.

29. The method of claim 19, wherein the reaction is with fluorescent compounds including the components thereof.

30. The method of claim 19, wherein the reaction is with biological fluids including the components thereof.

31. The method of claim 16, further comprising:
moving the liquid aspiration and dispensing nozzles on X-Y-Z axes of the liquid handling robot; and
dispensing the plurality of liquid samples from the corresponding plurality of liquid aspiration and dispensing nozzles; and
repeating the aspirating and dispensing of liquid samples to optimize liquid product concentration characteristics based on results of the spectrophotometric analysis.

32. A method of assaying a plurality of samples, comprising:
performing a plurality of reactions in a plurality of liquid aspiration and dispensing nozzles in a liquid handling robot; while
spectrophotometrically analyzing light passing through each of the plurality of liquid aspiration and dispensing nozzles.

33. The method of claim 32, wherein the samples are biological, biochemical or chemical samples.

34. The method of claim 32, wherein the reactions occur in flow cells in the plurality of liquid aspiration and dispensing nozzles in the liquid handling robot.

35. The method of claim 33, wherein spectrophotometrically analyzing light passing through each of the plurality of liquid aspiration and dispensing nozzles comprises:
sequentially analyzing light passing through each of the flow cells with a spectrophotometer, wherein the plurality of liquid aspiration and dispensing nozzles are multiplexed to the spectrophotometer.

36. The method of claim 35, wherein the spectrophotometer is multiplexed to receive optical signals from each of the flow cells.

37. A method of doing business, comprising:
simultaneously reacting a plurality of samples in a plurality of liquid aspiration and dispensing nozzles in a liquid handing robot;
spectrophotometrically analyzing each of the plurality of samples with a spectrophotometer, wherein each of the plurality of liquid aspiration and dispensing nozzles are multiplexed to the spectrophotometer; and
compiling result data of the spectrophotometric analysis of each of the plurality of samples.

38. The method of claim 37, wherein the samples are biological, biochemical or chemical samples.

39. The method of claim 37, further comprising:
selecting a preferred sample by analyzing the compiled results of the spectrophotometric analysis of each of the plurality of samples.

40. The method of claim 37, wherein the samples are spectrophotometically analyzed in real time.

41. The method of claim 37, further comprising:
exporting the result data of the spectrophotometric analysis of each of the plurality of samples.

42. An optical detection liquid handling system, comprising:
a liquid handling robot;
a plurality of liquid aspiration and dispensing nozzles connected to the liquid handling robot; and
a spectrophotometer, wherein each of the liquid aspiration and dispensing nozzles are multiplexed to the spectrophotometer.

43. The system of claim 42, wherein each of the liquid aspiration and dispensing nozzles comprise a flow cell, and wherein each of the flow cells are multiplexed to the spectrophotometer by a pair of fiber optic cables.

44. The system of claim 42, wherein the liquid handling robot is an X-Y-Z robot.

45. The system of claim 4, wherein each of the plurality of liquid aspiration and dispensing nozzles are independently operable.

46. The system of claim 41, wherein each of the flow cells is multiplexed to the spectrophotometer by a pair of fiber optic cables.

47. The system of claim 1, wherein each of the plurality of liquid aspiration and dispensing nozzles are independently operable.

48. The system of claim 16, wherein each of the plurality of liquid aspiration and dispensing nozzles are independently operable.
